(19) United States
(12) Patent Application Publication
(10) Pub. No.: US 2016/0053947 A1
(43) Pub. Date: Feb. 25, 2016

(54) LINEAR LUMINOUS STANDARD

(71) Applicant: David E. Patterson, Rio Rancho, NM (US)

(72) Inventor: David E. Patterson, Rio Rancho, NM (US)

(21) Appl. No.: 14/818,385

(22) Filed: Aug. 5, 2015

Related U.S. Application Data
(60) Provisional application No. 62/041,235, filed on Aug. 25, 2014.

(51) Int. Cl. F21K 99/00; F21V 21/22; F21S 8/00; F21V 15/01; F21V 23/00; F21V 8/00

(52) U.S. Cl. CPC F21K 9/50; F21V 23/003; G02B 6/0096; F21S 8/032; F21V 15/01; F21V 21/22; F21Y 2101/02

(57) ABSTRACT

A lighted emitting pole anchored to the ground. The bottom housing is bolted or anchored to an embedded support. The upper housing contains the light portion of the pole. The upper housing is constructed of an inner welded aluminum construction with optical film and an opaque acrylic tube or light guide. A fist donut shaped LED board with optics is mounted to a top of the upper housing and a second LED board with optics is mounted to a bottom of the upper housing. The LEDs emit light between the optical film and the light guide, which provides for an evenly distributed light throughout the pole. A cap is affixed to the top of the upper housing to protect the interior of the pole from the elements.

### RELATED APPLICATIONS

The present application claims priority to U.S. Provisional Application No. 62/041,235 filed Aug. 25, 2014, the specification of which is incorporated herein by reference.

### BACKGROUND OF THE INVENTION

1. Field of the Invention (Technical Field)

The presently claimed invention relates to pole structures and more particularly, to pole structures that have light features for substantially lighting the entire pole structure.

2. Background Art

Poles are generally structural elements that often get overlooked, unobserved, and used for various purposes. With the advent of LED technology, the challenge is to make the pole emit light and to hold up structurally. Instead of having a light fixture affixed to the pole structure, the presently claimed invention makes the pole a light fixture that provides evenly distributed light up and down the pole while providing the structural properties of a pole.

### BRIEF DESCRIPTION OF THE DRAWINGS

The accompanying drawings, are incorporated into and form a part of the specification, illustrate several embodiments of the present invention, and together with the description, serve to explain the principles of the invention. The drawings are only for the purpose of illustrating a preferred embodiment of the invention and are not to be construed as limiting the invention. In the drawings:

FIG. 1 is a front view of the preferred pole.

FIG. 2 is a top view of FIG. 1.

FIG. 3-1 is a partial exploded view of the upper portion FIG. 1.

FIG. 3-2 is a view of the upper portion of pole affixed to an exploded view of lower portion of pole.

FIG. 3-3 shows a close up view of the optical film affixed to inner tube.

### DESCRIPTION OF THE PREFERRED EMBODIMENTS

### Best Modes For Carrying Out The Invention

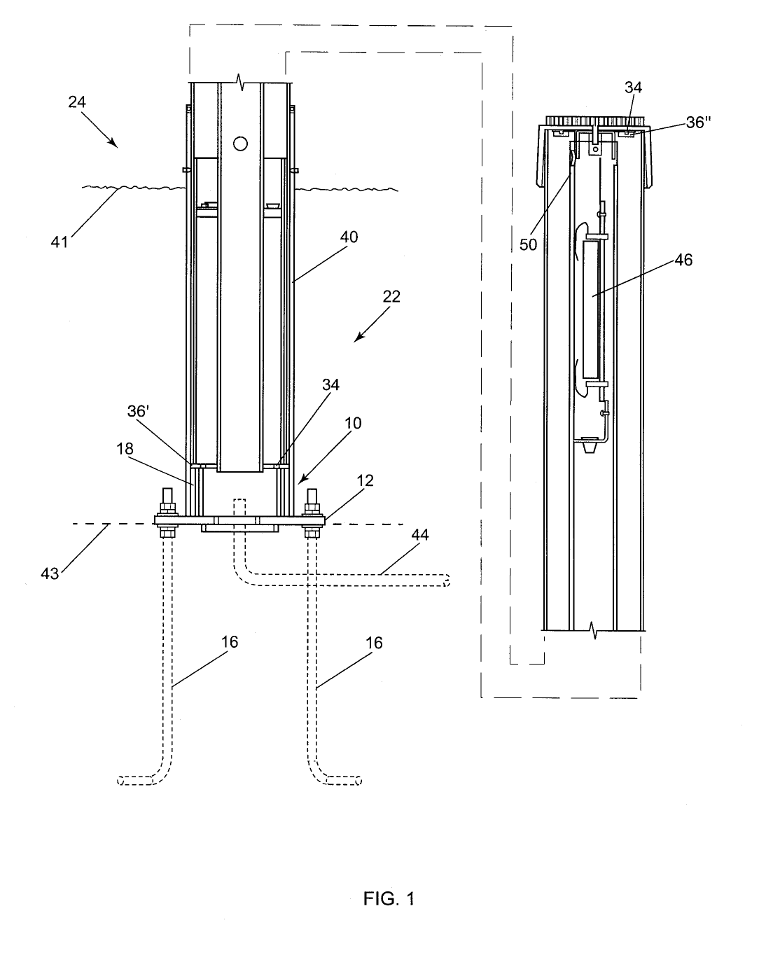

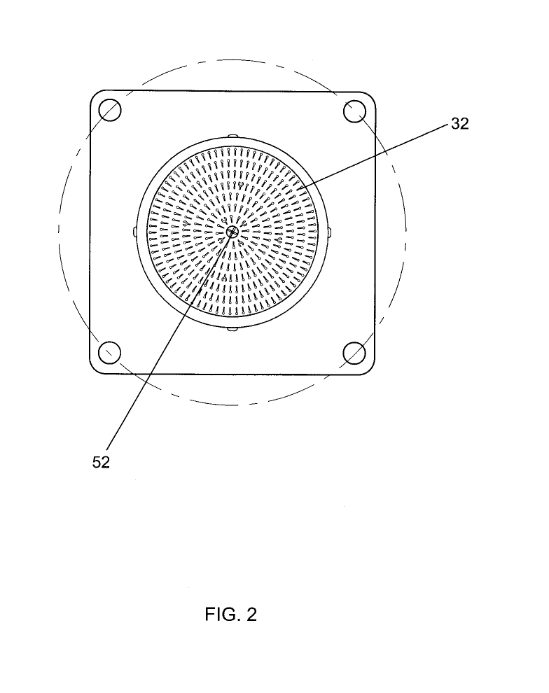

Shown in FIGS. 1, 2, 3-1, 3-2, and 3-3 is the preferred pole 24. The structural portion of pole or lower housing assembly 10 is preferably made of welded steel construction, consisting of a steel mounting plate 12 at base 14 for anchor bolt 16 mounting in the field, an outer housing 26 and internal blocks 18, such as setscrews, to set the internal height of upper housing assembly 22 when assembled. Adjustment is accomplished by raising or lowering upper housing assembly 22 to the desired height and then tightening internal blocks 20, such as setscrews, onto upper housing assembly. In methods well known in the art, anchor bolts 16 are secured into the ground or to a structure. A finished grade 41 can be placed on top of the anchored and mounted base 14, to embed a portion of lower housing assembly 10, as shown. In an alternative embodiment, lower housing assembly 10 can be secured as discussed above with the mounting assembly exposed and level with surface 43.

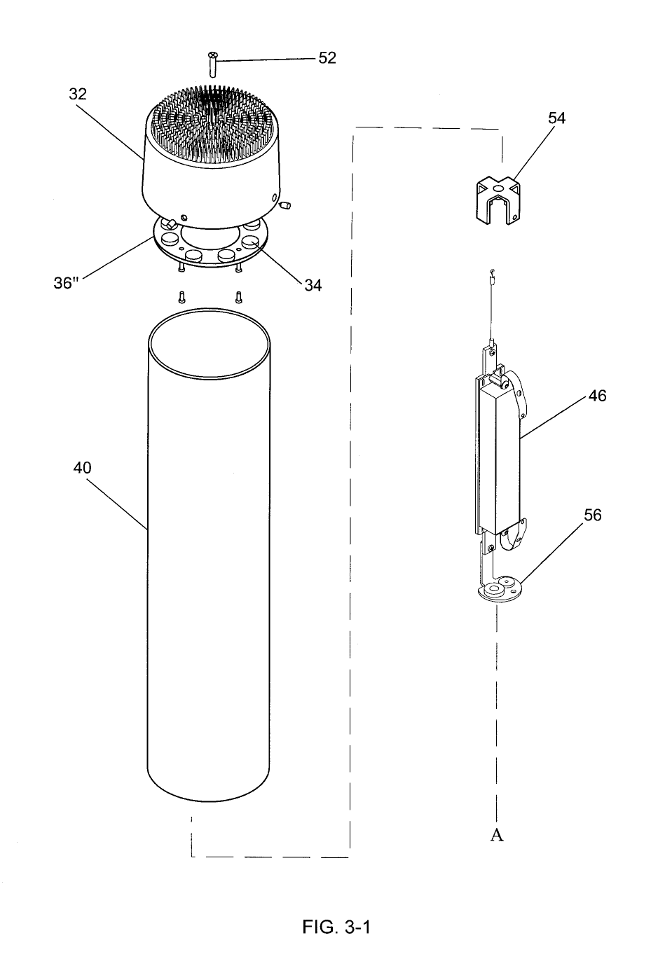

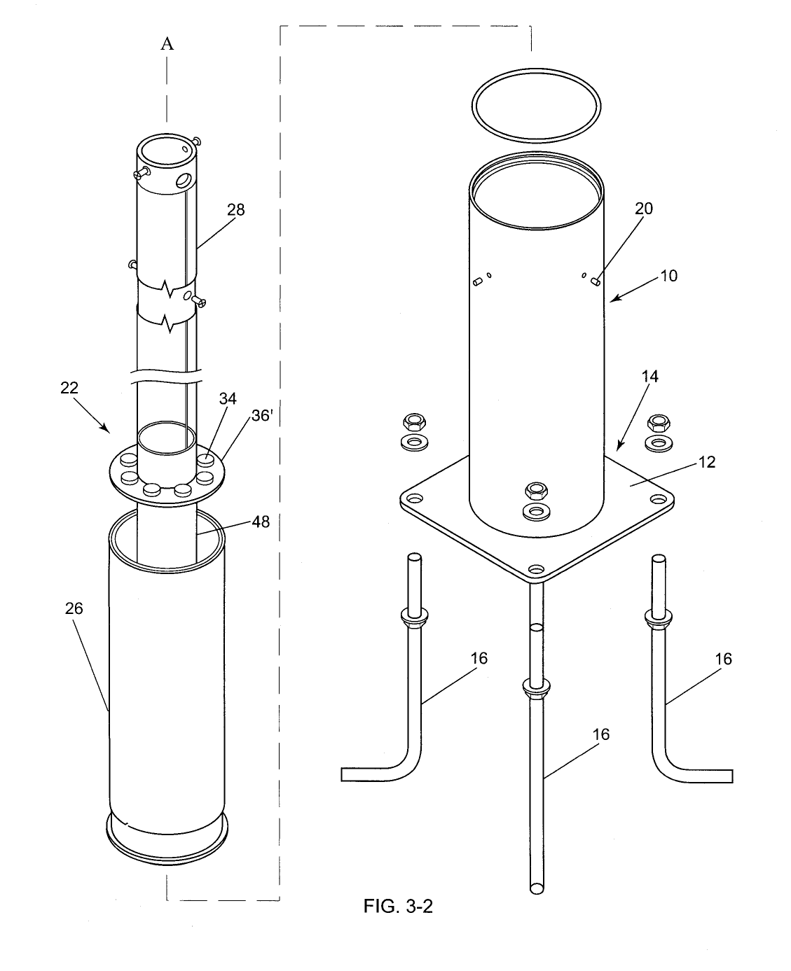

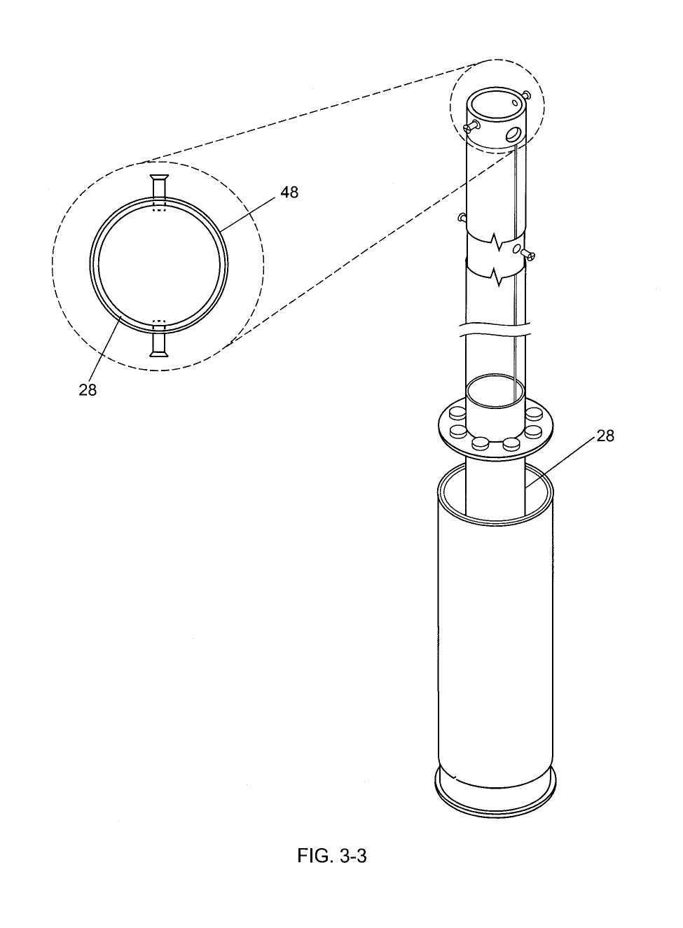

Upper housing 22 is the light portion of pole 24. Upper housing assembly 22 is preferably comprised of an inner housing 28 made from a rigid material, such as aluminum, with optical film 48, such as 3M® Optical Lighting Film (OLF) part number 70-0061-85-84-0 for optical lighting, an opaque acrylic tube 40, and top cap 32 with circuit boards 36, containing LED optics 34. The preferred optical film absorbs some of the light and reflects and refracts other aspects of the light wherein the combination of the three (3) make for a harmonious and continuous linear light flowing across the complete length of the film layer. Although, this disclosure identifies only the 3M® OLF, any similar property film can be utilized. The welded aluminum construction of inner housing 28 allows it to slide into lower housing assembly 10, which also adds structure to the height of pole 24. The height of pole 24 can be varied as desired. Optical film 48 is applied to the outside surface of inner tube 28, preferably comprising an aluminum pipe, which traverses from bottom to top of pole 24, as shown in FIG. 3-3. Thus, optical film 48 covers the outside surface of inner tube from the bottom to the top of the pole 24. A first LED array 36′ is located at the bottom of inner housing 28 and a second LED array 36″ is located at the innermost location on end cap 32, which is located at top of inner housing 50. Both LED arrays 36′ and 36″ are preferably donut shaped printed circuit boards with a center portion sized to fit around inner tube 38, with a predetermined number of LEDs 34 affixed to the circuit board. LED arrays 36 are secured in place to inner tube 28 using methods well known in the art. Acrylic tube or light guide 40 is placed over the inner tube 28 and LED arrays 36′ and 36″, as shown. Light guide 40 is fitted over a sized diameter receiving structure 42 on inner housing 26 on a first end, and end cap 32 on the second end. End cap 32 is pressed down, compressing light guide 40 onto sized diameter receiving structure 42 and held in place via setscrews 52 to end cap bracket 54. All wires 44 are routed through wire way cover 56 and the inside of inner tube 38 through the center of lower housing 10 to a remote location. The driver or power supply 46 can be used either remotely or located in a separate box (not shown) or an integral part slipped into the upper housing 22 assembly inner tube 38 using spring steel brackets to keep it in place.

The first LED array 36′ and second LED array 36″ utilize their standard beam angle of light to interact with optical film 48 traversing the complete length of inner tube 28 along with the opaque acrylic tube or light guide 40 to constantly bounce between the two, ultimately rising up and subsequently down the entire pole 24, yielding a uniform pattern of light.

Although the claimed invention has been described in detail with particular reference to these preferred embodiments, other embodiments can achieve the same results. Variations and modifications of the presently claimed invention will be obvious to those skilled in the art and it is intended to cover in all such modifications and equivalents. The entire disclosures of all references, applications, patents, and publications cited above, are hereby incorporated by reference.

What is claimed is:

1. A light emitting pole comprising:
an anchored lower housing; and
an upper housing disposed on the lower housing, the upper housing comprising an inner housing comprising an optical film, a first set of light emitting diodes (LEDs) disposed on a first end of the upper housing, a second set of LEDs disposed on a second end of the upper housing and a light guide encasing the upper housing.

2. The light emitting pole of claim 1 wherein the upper housing comprises an adjustable height upper housing.

3. The light emitting pole of claim 1 wherein the inner housing comprises a rigid tube.

4. The light emitting pole of claim 1 wherein the optical film comprises a film that absorbs a first predetermined amount of light, reflects a second predetermined amount of the light, and refracts a third predetermined amount of the light comprising a harmonious and continuous composite linear light flowing across a length of the film.

5. The light emitting pole of claim 1 wherein the first set of LEDs and the second set of LEDs each comprises a circuit board with the LEDs configured to direct the light between the optical film and the light guide.

6. The light emitting pole of claim 1 further comprising a driver for driving the first set and second set of LEDs.

7. The light emitting pole of claim 1 further comprising an end cap.

8. A method for lighting a pole, the method comprising the steps of:
illuminating a first set of LEDs between an optical film encasing an inner housing and a light guide, the first set of LEDs affixed to a top of an upper housing; and
illuminating a second set of LEDs between the optical film and the light guide, the second set of LEDs affixed to a bottom of the upper housing.

9. The method of claim 8 wherein the upper housing is affixed to an anchored lower housing.

10. The method of claim 8 wherein the inner housing comprises a rigid tube.

11. The method of claim 8 further comprising the step of adjusting a height of the upper housing.

12. The method of claim 8 further comprising the steps of the optical film absorbing a first predetermined amount of light, reflects a second predetermined amount of the light, and refracts a third predetermined amount of the light creating a harmonious and continuous composite linear light flowing across a length of the optical film.

13. The method of claim 8 wherein the first set of LEDs comprise a first circuit board and the second set of LEDs comprise a second circuit board, the first and second circuit boards configured to direct the light between the optical film and the light guide.

14. The method of claim 8 further comprising the step of driving the first and second set of LEDs with a driver.

15. The method of claim 8 further comprising the step of sealing the top of the upper housing with an end cap.

16. A system for lighting a pole comprising:
means for illuminating a first set of LEDs between an optical film encasing an inner housing and a light guide, the first set of LEDs affixed to a top of an upper housing; and
means for illuminating a second set of LEDs between the optical film and the light guide, the second set of LEDs affixed to a bottom of the upper housing.

17. The system of method of claim 16 wherein the upper housing is affixed to an anchored lower housing.

18. The system of claim 16 wherein the inner housing comprises a rigid tube.

19. The system of claim 16 further comprising a means for adjusting a height of the upper housing.

20. The system of claim 16 further comprising a means for the optical film absorbing a first predetermined amount of light, reflects a second predetermined amount of the light, and refracts a third predetermined amount of the light creating a harmonious and continuous composite linear light flowing across a length of the optical film.

21. The system of claim 16 wherein the first set of LEDs comprise a first circuit board and the second set of LEDs comprise a second circuit board, the first and second circuit boards configured to direct the light between the optical film and the light guide.

22. The system of claim 16 further comprising a means for driving the first and second set of LEDs.

23. The system of claim 16 further comprising a means for sealing the top of the upper housing with an end cap.
